(19) United States
(12) Patent Application Publication
(10) Pub. No.: US 2025/0162120 A1
(43) Pub. Date: May 22, 2025

(54) MULTIFUNCTIONAL TOOL WITH CENTRAL MEMBER AND INSERT

(71) Applicant: Multitasker Tools LLC, Atlanta, GA (US)

(72) Inventor: Shane Keng, Marietta, GA (US)

(21) Appl. No.: 18/954,298

(22) Filed: Nov. 20, 2024

Related U.S. Application Data
(60) Provisional application No. 63/601,534, filed on Nov. 21, 2023.

(51) Int. Cl. B25F 1/02; B25G 1/08; F41A 35/00

(52) U.S. Cl. CPC B25F 1/02; B25G 1/08; F41A 35/00

(57) ABSTRACT

Multifunctional tools are provided. A multifunctional tool may include a central member and/or an insert. The central member may have first and second ends. The first end may define a cavity designed to receive fasteners or bits. The second end may define an extruded tip designed for use as a pry tip, a sharpened edge, or a screwdriver blade and/or have a cutout designed for use as a bottle opener. The insert may be removably attachable to the central member and may be designed to hold fasteners or bits. The insert may include a magnet designed to retain the fasteners or bits. The tool may be modular and/or designed to accommodate a range of fasteners, bits, or other associated components. For example, any of the fasteners or bits associated with use of the tool may be hexagonal or round or may have any other shape according to user requirements.

### CROSS-REFERENCE TO RELATED APPLICATION

This application is related to, and claims the benefit of and priority to, U.S. Provisional Patent Application No. 63/601,534, filed Nov. 21, 2023, the entire contents of which are incorporated herein by reference.

### TECHNICAL FIELD

The present disclosure generally relates to multifunctional tools. For example, multifunctional handheld tools including central members with multiple integral tools and inserts designed to provide additional tools in compact and modular forms are provided herein.

### BACKGROUND

Advancements in small arms technology have increased at a rapid pace, especially with respect to military rifles and other high-performance firearms. Modern infantry, for example, demand that their firearms offer advanced sighting and illumination capabilities, which in return emphasizes a need for mounting a multitude of ancillary accessories on the handguard of a firearm, via either Picatinny or M-LOK® rail interface. To properly maintain and adjust these accessories requires a multitude of tools, as there is very little standardization among various suppliers of such equipment as to fastener sizes and other critical design features.

There are numerous designs offering the ability to hold interchangeable hexagonal bits (see, e.g., U.S. Pat. No. 10,112,292 to Keng for “MULTIPURPOSE HANDHELD TOOL AND ACESSORIES”), which may offer the ability for a user to replace a multitude of screwdrivers and Allen wrenches with a single tool. Separately, hexagonal wrenches or spanners (e.g., ½-inch nominal hexagonal wrenches or spanners) are commonly available tools used to tighten large hexagonal fasteners typically found securing sizeable optics mounts to rifles or other firearms.

However, as depicted by the separate multifunctional hand tool and spanner in FIG. 1, achieving the combined functionality of such multifunctional hand tools and spanners currently requires the availability and use of two separate tools. This issue is especially pronounced in scenarios where larger hexagonal wrenches or spanners (e.g., those having ½-inch nominal sizes) are required, as such wrenches or spanners generally require a great deal of leverage (and, by extension, increased size and operating space) to be employed effectively. As such, existing multipurpose handheld tools often fail to offer sufficient multifunctionality or include adequate tools to accommodate the needs of modern firearms and their accessories. Because, as a result, multiple separate tools are required, the footprint of gear that a modern infantryperson or other user must carry is substantial.

Accordingly, there is a need for a multifunctional tool that offers the ability to accomplish multiple tasks (particularly those associated with installation or maintenance of accessories for use with firearms) while requiring less space than existing combinations of separate tools.

### BRIEF DESCRIPTION OF THE DRAWINGS

FIG. 1 is a perspective view of an existing multipurpose handheld tool and an existing spanner.

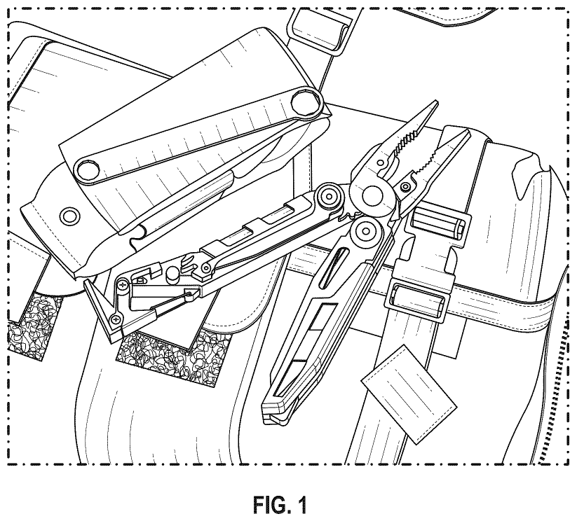

FIG. 2 is an exploded perspective view of an example multifunctional tool and associated components in accordance with one or more embodiments of the present disclosure.

FIG. 3 is an exploded perspective view of an example multifunctional tool and associated components in accordance with one or more embodiments of the present disclosure.

FIG. 4 is an exploded side view of an example multifunctional tool and associated components in accordance with one or more embodiments of the present disclosure.

### DETAILED DESCRIPTION

Some or all of the needs and issues referenced above may be addressed by embodiments of the multifunctional tool disclosed herein. According to an embodiment of the present disclosure, for example, a multifunctional tool may include a central member and/or an insert. The central member may have a first end and a second end. The first end of the central member may define a first cavity designed to receive a first fastener (e.g., for use as a wrench or spanner) or a first bit. The second end of the central member may define an extruded tip designed for use as a pry tip, a sharpened edge, a screwdriver blade, or another tool. The second end may, alternatively or in addition, have a cutout designed to receive a bottle cap of a bottle for opening the bottle. The insert may be removably attachable to the central member and may be designed to hold fasteners or interchangeable bits. The insert may, for instance, include a magnet designed to retain the interchangeable bits within the insert during use. The tool may be modular and/or may be designed to accommodate a range of fasteners, bits, or other associated components. For example, any of the fasteners or bits associated with use of the tool may be hexagonal or round or may have any other shape or profile as needed or preferred by a user.

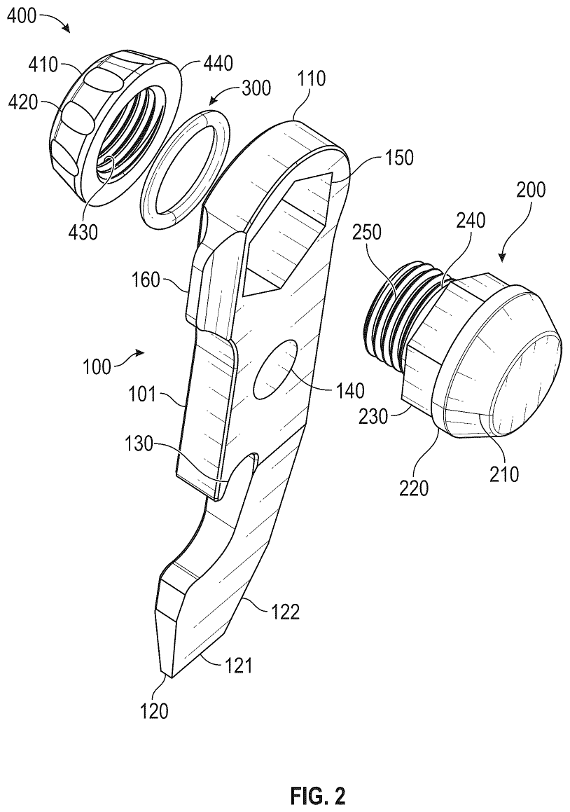

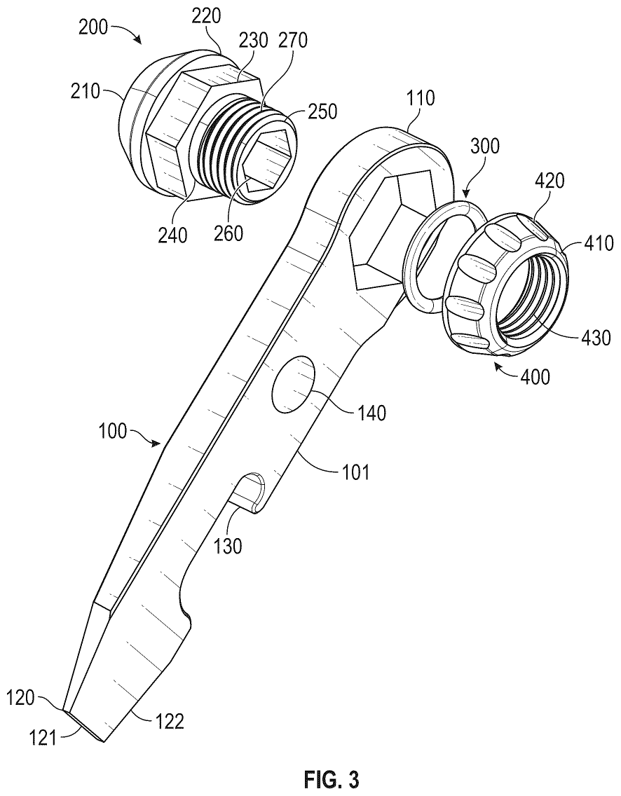

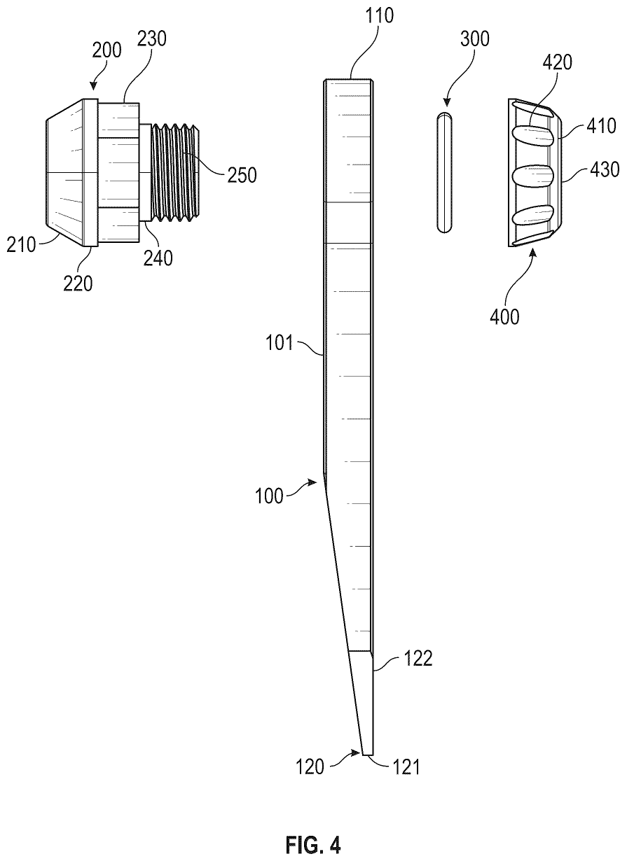

Referring now to FIGS. 2-4, and in brief overview, a multifunctional tool including a central member and an insert is depicted. The multifunctional tool may be handheld and/or may be used for any suitable purpose. For example, the multifunctional tool may include a multipurpose handheld tool with components or accessories designed for use with a firearm, firearm accessories, and associated systems, devices, or components. The multifunctional tool may be modular to offer increased customization and multifunctionality.

As shown in FIGS. 2-4, tool 100 may include central member 101 and/or insert 200. Central member 101 may extend to first end 110 and/or second end 120. First end 110 may define first cavity 150. Second end 120 may define extruded tip 121 with or without cutout 130. First cavity 150 may have a first profile selected such that a first fastener or a first bit may be received within first cavity 150. For example, the first profile of first cavity 150 may be a first hexagonal profile, the first fastener may be a first hexagonal nut, and/or the first bit may be a first hexagonal-shank bit. A nominal size of the first profile may be selected, for instance, to accommodate sizes of the first fastener and/or the first bit that are commonly used in a preferred application (e.g., ½-inch nominal size to accommodate ½-inch hexagonal nuts commonly used in optics mounts and other accessories used with firearms).

First cavity 150 may be designed to accept insert 200. Insert 200 may be designed to be removably attached to first end 110 of central member 101. For example, insert 200 may have step 220 (which may, for instance, be cylindrical in profile) extending from closed end 210 before transitioning to alignment feature 230 (which may, for instance, be a step or extrusion having a round, hexagonal, or any other profile corresponding to the first profile of first cavity 150 such that insert 200 may be properly aligned with respect to first end 110 of central member 101) followed by male extension 250. Insert 200 may be inserted into first cavity 150 such that male extension 250 may extend beyond first cavity 150. Male extension 250 may have external threads 270, which may remain exposed when insert 200 has been inserted into first cavity 150. Retaining nut 400, which may have internal threads 430 corresponding to external threads 270 of male extension 250 of insert 200, may be used to tighten insert 200 onto tool 100 about first end 110 of central member 101. For example, retaining nut 400 may have tapered end 410 with any number of fluting cuts 420, which may provide for easier tightening or loosing of retaining nut 400 relative to insert 200 by hand and/or via use of a separate tool. Insert 200 may define recessed portion 240 (e.g., at a transition between alignment feature 230 and male extrusion 250), which may be designed to receive gasket or O-ring 300. Gasket or O-ring 300 may be designed to form an interference fit between insert 200 and retaining nut 400 to prevent their unintentional loosening, for example, when insert 200 is inserted within first cavity 150 and retaining nut 400 has been tightened about insert 200.

Insert 200 may define second cavity 260 opposite closed end 210. Second cavity 260 may have a second profile, which may be any shape or design (e.g., round or hexagonal) such that second cavity 260 may receive a second fastener or a second bit with insert 200 attached to first end 110 of central member 101. For example, the second profile of second cavity 260 of insert 200 may be a second hexagonal profile, the second fastener may be a second hexagonal nut, and/or the second bit may be a second hexagonal-shank bit. Insert 200 may include a magnet (not shown) located within second cavity 260. The magnet may be designed to removably retain the second fastener and/or the second bit within second cavity 260, which may prove helpful, for instance, should a user desire to insert any number of interchangeable bits into second cavity 260 to tighten, loosen, or otherwise adjust any number of external fasteners or other components.

The second profile of second cavity 260 may be the same as or different than the first profile of first cavity 150. By providing for first cavity 150 and second cavity 260 to have different profiles, tool 100 may be able to facilitate use of a wider variety of fasteners and/or bits. For example, where the first profile of first cavity 150 is different than the second profile of second cavity 260, the first fastener and/or the first bit that may be received by first cavity 150 may differ from the second fastener and/or the second bit that may be received by second cavity 260. As such, central member 101 and insert 200 may offer a modular combination of tools for use in any number of applications or settings.

For example, tool 100 may be designed such that central member 101 may be used as a wrench or spanner to tighten, loosen, or otherwise adjust any number of fasteners with insert 200 removed from first end 110 of central member 101. When insert 200 and retaining nut 400 have previously been installed about first end 110, for instance, retaining nut 400 may be unscrewed, and insert 200 may thereafter be removed from first cavity 150. With first cavity 150 exposed, first end 110 of central member 101 may be used as a wrench or spanner, with first cavity 150 receiving the first fastener (e.g., a ½-inch-diameter hexagonal nut such as a retention nut commonly used to affix an optics mount to a rail of a rifle or other firearm) for adjustment and central member 101 providing sufficient leverage for tightening or loosening of the first fastener.

First end 110 of central member 101 may define any head profile suitable for the central member 101 to be used in any number of applications. For example, first end 110 may be round, cylindrical, or circular to provide for a smooth tool surface and/or to reduce wear to tool 100, external systems or components, or garments or accessories of users. Alternatively, first end 110 may be hexagonal to accommodate external tools for tightening or other adjustment purposes as required by the various components included with tool 100 (e.g., the wrench or spanner that may be included as part of central member 101). Central member 101 may include any number of other features or components designed to improve functionality of the various tool components included with tool 100. For example, first end 110 may have tapered portion 160, which may provide a suitable location for contact or engagement, by hand or via any number of separate tools, or for various other purposes as needed with respect to any particular application.

Tool 100 may include any number of additional or alternative tools or components in any number of modular configurations, arrangements, or designs. For example, extruded tip 121 of central member 101 may be designed as a first tool for use in any suitable purpose or application. Extruded tip 121 may, for instance, include a pry tip, a sharpened edge, a screwdriver blade, and/or any other tool having an extruded feature suitable for placement at second end 120 of central member 101. Cutout 130 may be designed as a second tool for use in any suitable purpose or application. For example, cutout 130 may have a shape or profile selected to receive a bottle cap of a bottle and/or a lid of a can such that cutout 130 may function as a bottle opener and/or a can opener. A shape, profile, or design of cutout 130 may be selected such that cutout 130 may be used to perform its intended function (e.g., removing a bottle cap from a bottle and/or removing a lid from a can) without unduly sacrificing structural integrity necessary for extruded tip 121 to also perform its intended function (e.g., prying, cutting or chipping, or screwdriving), which may require second end 120 of central member 101 to exhibit a substantial yield strength. As such, second end 120 of central member 101 may effectively include multiple tools, within a consolidated space, in a form that ensures the longevity and durability of tool 100.

Central member 101 may define hole 140, which may be located between first end 110 and second end 120. Hole 140 may be designed to receive a third fastener, a third bit, or an attachment component. For example, the third fastener and/or the third bit may be, respectively, a third hexagonal nut and/or a third hexagonal-shank bit. The attachment component may include any component or fastener designed to removably attach tool 100 to a garment or an accessory of a user, including but not limited to a lanyard, a rivet, a snap fastener, a bolt, a pin, a paddle attachment, or any other attachment fastener. Hole 140 may be either hexagonal (e.g., to accommodate the third hexagonal nut and/or the third hexagonal-shank bit), round (to accommodate the attachment component), or any other shape as needed.

Central member 101 may be formed, manufactured, or otherwise assembled from any number of materials and/or using any known methods of formation, manufacturing, or assembly. For example, central member 101 may be formed or molded from a unitary piece of material or may be assembled from any number of pieces of one or more materials. The material(s) of central member 101 may be any material suitable for use as a central member of a multifunctional tool (e.g., any material having acceptable characteristics related to strength, durability, corrosion resistance, weight, or any other criteria as determined by a particular application or scenario in which tool 100 might be used). The material may be or include metal material such as aluminum, steel (including carbon, alloy, stainless, or tool steel), and/or any other metal. Alternatively, or in addition, the material may be or include synthetic or composite material such as plastic (including nylon, thermoplastic such as acrylonitrile butadiene styrene (ABS) or thermoplastic elastomer (TPE) over-molding, and/or glass fiber-reinforced plastic) and/or any other synthetic or composite material. Although potential materials to be used in forming, manufacturing, or assembling central member 101 are described herein, it will be understood that any other components described or envisioned by the present disclosure may similarly be formed, manufactured, or assembled from any number of suitable materials.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A multifunctional tool comprising:
a central member extending to a first end and a second end, the first end defining a first cavity having a first profile, and the second end defining an extruded tip with a cutout, wherein:
the first cavity is configured to receive a first fastener or a first bit,
the extruded tip is configured as a first tool, and
the cutout is configured as a second tool; and
an insert, configured to be received by the first cavity, the insert defining a second cavity having a second profile, wherein:
the insert is further configured to be removably coupled to the first end via a retaining nut, and
the second cavity is configured to receive a second fastener or a second bit with the insert coupled to the first end.

2. The multifunctional tool of claim 1, wherein the second profile is different than the first profile.

3. The multifunctional tool of claim 2, wherein the first profile is a first hexagonal profile, the first fastener is a first hexagonal nut, and the first bit is a first hexagonal-shank bit.

4. The multifunctional tool of claim 3, wherein the first hexagonal profile has a ½-inch nominal size.

5. The multifunctional tool of claim 3, wherein the second profile is a second hexagonal profile, the second fastener is a second hexagonal nut, and the second bit is a second hexagonal-shank bit.

6. The multifunctional tool of claim 1, wherein the first tool is a pry tip, a sharpened edge, or a screwdriver blade.

7. The multifunctional tool of claim 1, wherein the second tool is a bottle opener configured to receive a bottle cap of a bottle for opening the bottle.

8. The multifunctional tool of claim 1, wherein the central member further defines a hole between the first end and the second end, the hole configured to receive a third fastener, a third bit, or an attachment component.

9. The multifunctional tool of claim 8, wherein the attachment component comprises a lanyard.

10. The multifunctional tool of claim 8, wherein the attachment component comprises a rivet, a snap fastener, a bolt, a pin, a paddle attachment, or a different attachment fastener configured to removably attach the multifunctional tool to a garment or an accessory of a user.

11. The multifunctional tool of claim 1, wherein the insert comprises a magnet disposed within the second cavity, the magnet configured to removably retain the second fastener or the second bit within the second cavity.

12. The multifunctional tool of claim 1, wherein the insert further defines a recessed portion configured to receive a gasket or an O-ring, the gasket or the O-ring configured to form an interference fit between the insert and the retaining nut.

13. The multifunctional tool of claim 1, wherein the retaining nut comprises a tapered end with a plurality of fluting cuts.

14. The multifunctional tool of claim 1, wherein the first cavity is configured for use as a spanner with the insert removed from the first end.

15. The multifunctional tool of claim 1, wherein the first end further defines a first round head profile.

16. The multifunctional tool of claim 1, wherein the first end further defines a first hexagonal head profile.

17. The multifunctional tool of claim 1, wherein the central member is formed from a unitary piece of material.

18. The multifunctional tool of claim 17, wherein the unitary piece of material is a metal material.

19. The multifunctional tool of claim 17, wherein the unitary piece of material is a synthetic or composite material.

20. A multifunctional tool comprising:
a central member extending to a first end and a second end and defining a hole therebetween, the central member formed from a unitary piece of metal, synthetic, or composite material, the first end defining a first cavity having a first hexagonal profile, and the second end defining an extruded tip with a cutout, wherein:
the first cavity is configured to receive a first hexagonal nut or a first hexagonal-shank bit having a ½-inch nominal size,
the extruded tip is configured as a pry tip, a sharpened edge, or a screwdriver blade,
the cutout is configured to receive a bottle cap of a bottle for opening the bottle,
the hole is configured to receive a round or hexagonal fastener, a round- or hexagonal-shank bit, or an attachment component, and
the attachment component comprises a lanyard, a rivet, a snap fastener, a bolt, a pin, a paddle attachment, or a different attachment fastener configured to removably attach the multifunctional tool to a garment or an accessory of a user; and
an insert, configured to be received by the first cavity, the insert defining a recessed portion and a second cavity having a second hexagonal profile different than the first hexagonal profile, wherein:
the insert is further configured to be removably coupled to the first end via a retaining nut, the retaining nut comprising a tapered end with a plurality of fluting cuts,
the recessed portion is configured to receive a gasket or an O-ring, the gasket or the O-ring configured to form an interference fit between the insert and the retaining nut,
the second cavity is configured to receive a second hexagonal fastener or a second hexagonal-shank bit with the insert coupled to the first end,
the insert comprises a magnet disposed within the second cavity, the magnet configured to removably retain the second hexagonal fastener or the second hexagonal-shank bit within the second cavity, and
the first cavity is configured for use as a spanner with the insert removed from the first end.
